(19) United States
(12) Patent Application Publication
(10) Pub. No.: US 2010/0328035 A1
(43) Pub. Date: Dec. 30, 2010

(54) SECURITY WITH SPEAKER VERIFICATION

(75) Inventors: STEPHEN HANLEY, Boynton Beach, FL (US); PEEYUSH JAISWAL, Boca Raton, FL (US); JAMES ROBERT LEWIS, Delray Beach, FL (US)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/493,749

(22) Filed: Jun. 29, 2009

(51) Int. Cl. G05B 19/00

(52) U.S. Cl. 340/5.84; 704/273

(57) ABSTRACT

A data base is created for storage of voice prints of requesters that are believed to be fraudulently attempting to access information for which they are not authorized to obtain. When a user opens an account a voice print is obtained and stored. The user also provides answers to security related questions. When a requester tries to access the information, they must be authenticated by providing a voice print and answers to the security questions. If the voice print and answers do not result in a satisfactory match based on predetermined criteria, access is denied and the voice print is stored as a possibly fraudulent voice print. Subsequent access attempts are compared to the stored possibly fraudulent voice print which is reclassified as a likely fraudulent voice print if matched. Thus, unauthorized access is less likely.

### BACKGROUND

1. Field of the Invention

The present invention relates to internet security, and more specifically, to improved security for voice recognition systems.

2. Description of the Related Art

Interactive Voice Response (IVR) is an interactive technology that allows a computer to detect voice and keypad inputs. IVR technology is used extensively in telecommunications to allow customers to access a company's database via a telephone touchtone keypad or by speech recognition, after which they can service their own enquiries by following the instructions. Additionally, IVR systems can use Speaker Verification to determine if a speaker who claims to be of a certain identity is that person, and the voice is used to verify this claim.

As the use of IVR technology and Speaker Verification increases, so does the time and effort to defeat the technology. If a person tries to fraudulently break into an IVR that uses Speaker Verification, the person might try multiple accounts in an attempt to find the 1-2% of individuals whose voice model is a close match to the unauthorized user's voice. Once identified, the unauthorized user's voice may be used to create a voice model for access.

### SUMMARY

According to one embodiment of the present invention, detection and denial of unauthorized access to a user account containing private information is improved. A voice print of an authorized user is stored in a database on a computer. In addition, answers to predetermined security questions provided by the authorized user are also stored in a database on a computer. All requests for access from a requester are authenticated prior to granting access to the private information. Authentication comprises comparing a voice print obtained from the requester with the stored voice print of the authorized user. Authentication also comprises comparing responses to the predetermined security questions provided by the requester with the stored answers provided by the authorized user;

If the voice print from the requester and the responses do not provide a satisfactory match based on predetermined criteria, access is denied and the voice print obtained from the requester is stored in a possibly fraudulent voice print data base. The predetermined criteria may include allowing access if responses are correct but the voice print does not match.

Voice prints of future requesters are compared to both the voice print of the authorized user and to the voice print(s) in the possibly fraudulent voice print data base. Upon occurrence of a match between the future requester's voice print to one of the possibly fraudulent voice prints, the possibly fraudulent voice print is reclassified as a likely fraudulent voice print. The user's account is then locked to the requester.

### BRIEF DESCRIPTION OF THE SEVERAL VIEWS OF THE DRAWINGS

The foregoing and other features and advantages of the present invention will be more fully understood from the following detailed description of illustrative embodiments, taken in conjunction with the accompanying drawings, in which:

FIG. 1 is an illustration of the present invention in operation; and

FIG. 2 is a flowchart of the steps utilized to perform the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to a flowchart illustration and a diagram of methods, apparatus (systems) and computer program products according to embodiments of the invention. It will be understood that each block of the flowchart illustration and/or diagram, and combinations of blocks in the flowchart illustrations and/or diagram, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

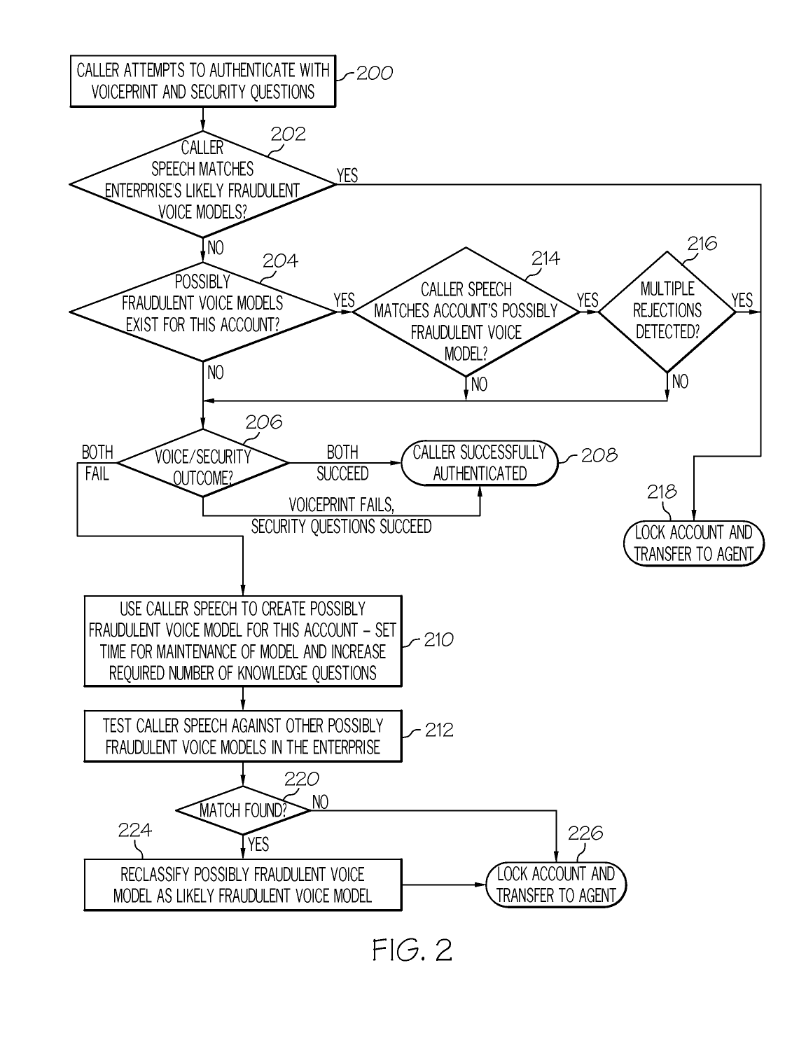

The flowchart in FIG. 2 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart, and combinations of blocks in the flowchart, can be implemented by special purpose hardware-based systems that perform the specified functions or acts, or combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart.

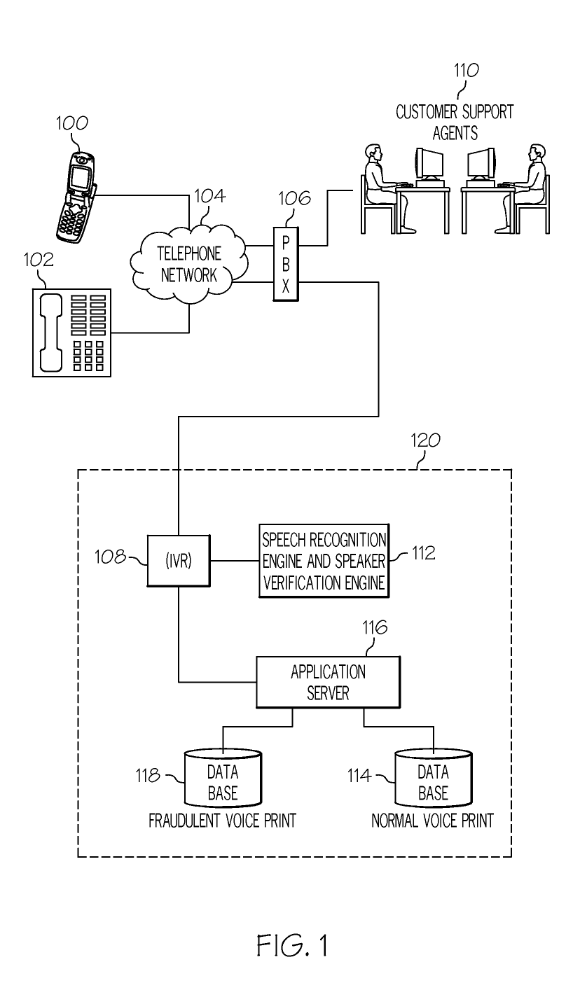

With reference now to FIG. 1, an embodiment of the present invention is shown. Each user who accesses an automated system is verified against an account's knowledge information and a voiceprint that has been created using their speech. Typically, the user is required to respond to a number of questions, and the answers are compared with those entered when the account was set up.

When the user needs to access their account, the user places a call using a telephone device such as a cellular phone 100 or a land line phone 102 through a telephone network 104. A private branch exchange (PBX) 106, which serves the account, connects the user to an Interactive Voice Response (IVR) 108, or, alternatively, to a Customer Support Agent generally identified by reference numeral 110. The IVR 108 is connected to Speech Recognition and Speaker Verification Engine 112 (hereinafter referred to as Engines 112).

When the user calls, he/she is connected through the various components described above to the Engines 112. The user is required to answer security questions (mother's maiden name, first job, account number, etc.), and the user's voice is compared to the voiceprint on file and stored in Normal Voice Print data base 114. The Normal Voice Print data base 114 may be accessed through an application server 116. If the user's answers and voice print comparison are correct, the user is permitted access to their account. However, if an unauthorized user is attempting access, they are denied, and their voiceprint is stored in a Fraudulent Voice Print data base 118. As shown in FIG. 1 and indicated by reference numeral 120, the present invention components including IVR 108, Engines 112, Application Server 116, Normal Voice Print data base 114, and Fraudulent Voice Print data base 118 may comprise one or more general purpose computing devices.

When the caller's speech does not match the account's authorized voiceprint(s) and the individual could not authenticate against the knowledge questions asked, then the individual's speech that has been gathered during the attempted authentication is stored in a Fraudulent Voice Print data base 118, and an associated Possibly Fraudulent Voice Model is created. When subsequent access attempts are made to that same account within a specific period of time, the speech is matched against the account's Possibly Fraudulent Voice Models and the number of knowledge questions needed for authentication is increased, if a match is found. After multiple rejections to access a single account are detected, the account is locked from access by anyone whose speech matches one of the account's Possibly Fraudulent Voice Models.

Each time an individual is rejected for access to an account, the individual's speech is compared to all of the Possibly Fraudulent Voice Models created for an enterprise during a specified period of time. When multiple rejections are discovered on different accounts for the same speaker, the Possibly Fraudulent Voice Model is promoted to the status of a Likely Fraudulent Voice Model. All accounts accessed during a specified period of time will be checked against the Likely Fraudulent Voice Models. If a match is found, then access to the account is escalated and automated access is denied.

Referring now to FIG. 2, a flowchart describing the present invention is shown. In block 200, a caller/user attempts to authenticate with a voiceprint and answer security questions. At decision block 202, it is determined whether or not the caller's speech matches a Likely Fraudulent Voice Model. If the answer to decision block 202 is yes, the account is locked, and the caller is transferred to an agent (such as one of the Customer Support Agents 110 in FIG. 1) in block 218.

If the answer to decision block 202 is no, the present invention proceeds to decision block 204. It is then determined whether or not there is a Possibly Fraudulent Voice Model for this account. If the response to decision block 204 is yes, it is determined at decision block 214 whether or not the caller's speech matches the account's Possibly Fraudulent Voice Model. If the response is yes, the invention proceeds to decision block 216. In decision block 216 it is determined if there are multiple rejections for this caller's speech. If the response is yes, the account is locked and the caller is transferred to an agent at block 218.

If the response to decision blocks 204, 214 or 216 is no, the present invention proceeds to decision block 206. At block 206 the outcome of the voice and security questions is determined. If both succeed, the caller is successfully authenticated at block 208. If the voiceprint fails but the security questions are correctly answered, the invention also authenticates the caller at block 208. This authentication outcome is allowed since current voiceprint technologies have relatively high error rates compared to other biometric technologies. It is rare for a system to make an authentication decision based solely on matching or failing to match a voiceprint. Authentication requirements will differ from implementation to implementation, but one approach is for a caller to surpass an authentication score based on different criteria, such as knowing the answers to one or more security questions, knowing a Personal Identification Number (PIN) or other passcode, or calling from a phone number associated with the account (detected using Automatic Number Identification (ANI)).

If both the voice and security questions answers fail at decision block 206, the invention goes to block 210. The caller's speech is then used to create a Possibly Fraudulent Voice Model for this account. In addition, a time is set for maintenance of the model, and an increased number of security questions becomes required for subsequent access attempts corresponding to this voiceprint. The time set for maintenance of the model is a time frame for closer monitoring, if a programmed period of time passes without further attempts to break into the account, the authentication defaults will be restored, including the reduction of the number of security questions (or other security criteria associated with the authentication score) to the former level. Then, at block 212, the caller's speech is tested against other Possibly Fraudulent Voice Models already stored by this enterprise, as described above in reference to FIG. 1.

It is determined at block 220 whether or not there is a match to other Possibly Fraudulent Voice Models already stored in this enterprise. If the response is yes, the Possibly Fraudulent Voice Model is reclassified as a Likely Fraudulent Voice Model by the enterprise at block 224. If the response to block 220 is no or after block 224, the account is locked and the user is transferred to an agent at 226.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for improving detection and denial of unauthorized access to a user account containing private information, comprising the steps of:
storing a voice print of an authorized user in a first database on a first computer;
storing answers to predetermined security questions provided by said authorized user in a second database on a second computer;
authenticating all requests for access from a requester prior to granting access to the private information;
said step of authenticating further comprising a step of comparing a voice print obtained from said requester with said stored voice print of said authorized user;
said step of authenticating further comprising a step of comparing responses to said predetermined security questions provided by said requester with said stored answers provided by said authorized user;
if said voice print from said requester and said responses do not provide a satisfactory match based on predetermined criteria, denying access and storing said voice print obtained from said requester in a possibly fraudulent voice print data base on a third computer;
comparing voice prints of future requesters to both said voice print of said authorized user in said second data base and to said voice print in said possibly fraudulent voice print data base;
upon occurrence of a match between said future requester's voice print to one in said possibly fraudulent voice print data base, reclassifying said possibly fraudulent voice print as a likely fraudulent voice print; and
locking said user account to said requester.

2. The method of claim 1, further comprising the step of defining said predetermined criteria to include approval when said responses match said stored answers but said voice print from said requester does not match said voice print of said authorized user.

3. The method of claim 1, wherein said step of denying access and storing said voice print obtained from said requester includes increasing a number of security questions for subsequent access attempts.

4. The method of claim 3, wherein said step of denying access and storing said voice print obtained from said requester in a possibly fraudulent voice print data base further comprises the step of creating a maintenance time for which said increased number of security questions for subsequent access attempts is required.

5. The method of claim 1, wherein said step of locking said user account to said requester further comprises the step of sending said requester to a customer support person for further action.

6. The method of claim 1, wherein said first and second computers are the same computer.

7. The method of claim 1, wherein said first, said second and said third computers are the same computer.

8. A system for improved detection and denial of unauthorized access to a user account containing private information, said system comprising:
a first database on a first computer for storing a voice print of an authorized user;
a second database on a second computer for storing answers to predetermined security questions provided by said authorized user;
means for authenticating all requests for access from a requester prior to granting access to the private information;
said means for authenticating further comprises a comparison of a voice print obtained from said requester with said stored voice print of said authorized user;
said means for authenticating further comprises a comparison of responses to said predetermined security questions provided by said requester with said stored answers provided by said authorized user;
a possibly fraudulent voice print data base on a third computer for storing said voice print obtained from said requester if said voice print from said requester and said responses do not provide a satisfactory match, based on predetermined criteria, and means for denying access to the user account by said requester;
means for comparing voice prints of future requesters to both said voice print of said authorized user in said second data base and to said voice print in said possibly fraudulent voice print data base;
upon occurrence of a match between said future requester's voice print to one in said possibly fraudulent voice print data base, means for reclassifying said possibly fraudulent voice print as a likely fraudulent voice print; and
means for locking said user account to said requester.

9. The system of claim 8, wherein said predetermined criteria includes approval when said responses match said stored answers but said voice print from said requester does not match said voice print of said authorized user.

10. The system of claim 8, wherein said means for denying access and storing said voice print obtained from said requester includes increasing a number of security questions for subsequent access attempts.

11. The system of claim 10, wherein said means for denying access and storing said voice print obtained from said requester in a possibly fraudulent voice print data base further comprises means for creating a maintenance time for which said increased number of security questions for subsequent access attempts is required.

12. The system of claim 8, wherein said means for locking said user account to said requester further comprises means for sending said requester to a customer support person for further action.

13. The system of claim 8, wherein said first and second computers are the same computer.

14. The system of claim 8, wherein said first, said second and said third computers are the same computer.

15. A computer program product embodied in a computer readable medium for improved detection and denial of unauthorized access to a user account containing private information, said computer program product comprising:
a first database on a first computer for storing a voice print of an authorized user;
a second database on a second computer for storing answers to predetermined security questions provided by said authorized user;
means for authenticating all requests for access from a requester prior to granting access to the private information;
said means for authenticating further comprises a comparison of a voice print obtained from said requester with said stored voice print of said authorized user;
said means for authenticating further comprises a comparison of responses to said predetermined security questions provided by said requester with said stored answers provided by said authorized user;
a possibly fraudulent voice print data base on a third computer for storing said voice print obtained from said requester if said voice print from said requester and said responses do not provide a satisfactory match, based on predetermined criteria, and means for denying access to the user account by said requester;
means for comparing voice prints of future requesters to both said voice print of said authorized user in said second data base and to said voice print in said possibly fraudulent voice print data base;
upon occurrence of a match between said future requester's voice print to one in said possibly fraudulent voice print data base, means for reclassifying said possibly fraudulent voice print as a likely fraudulent voice print; and
means for locking said user account to said requester.

16. The computer program product of claim 15, wherein said predetermined criteria includes approval when said responses match said stored answers but said voice print from said requester does not match said voice print of said authorized user.

17. The computer program product of claim 15, wherein said means for denying access and storing said voice print obtained from said requester includes increasing a number of security questions for subsequent access attempts.

18. The computer program product of claim 17, wherein said means for denying access and storing said voice print obtained from said requester in a possibly fraudulent voice print data base further comprises means for creating a maintenance time for which said increased number of security questions for subsequent access attempts is required.

19. The computer program product of claim 15, wherein said means for locking said user account to said requester further comprises means for sending said requester to a customer support person for further action.

20. The computer program product of claim 15, wherein said first and second computers are the same computer.
